(19) United States
(12) Patent Application Publication
(10) Pub. No.: US 2026/0036318 A1
(43) Pub. Date: Feb. 5, 2026

(54) TECHNOLOGIES FOR THERMOSTATS

(71) Applicant: DiversiTech Corporation, Duluth, GA (US)

(72) Inventors: Christopher Bles, Golden, CO (US); Alexander Reed Jennes, Greeley, CO (US); Nathan Curry, Lakewood, CO (US)

(21) Appl. No.: 19/288,885

(22) Filed: Aug. 1, 2025

Related U.S. Application Data
(60) Provisional application No. 63/678,959, filed on Aug. 2, 2024.

(51) Int. Cl. F24F 11/56; F24F 11/30

(52) U.S. Cl. CPC F24F 11/56; F24F 11/30

(57) ABSTRACT

A system comprising a mobile computing terminal having a first network interface and a thermostat having a second network interface. The first network interface and the second network interface directly pair with each other such that the mobile computing terminal can be operated by a user to push a preset or customized setting for an HVAC component onto the thermostat. Through such pairing, the mobile computing terminal may also control the thermostat or receive runtime data from the thermostat, which allows the user to test the preset or customized setting for the HVAC component. Therefore, the system enables the mobile computing terminal to directly configure or control the thermostat, without the mobile computing terminal needing to connect to a network intermediary to do so. Additionally, the system enables the user to minimize going outdoors during such configuration or control, thereby minimizing exposure to adverse, difficult or unsafe ground conditions.

### CROSS-REFERENCE TO RELATED PATENT APPLICATION

This patent application claims a benefit of priority to U.S. Provisional Patent Application 63/678,959 filed on 2 Aug. 2024, which is incorporated by reference herein for all purposes.

### TECHNICAL FIELD

This disclosure relates to thermostats.

### BACKGROUND

A resident (e.g., a homeowner, a renter) may reside in a house (e.g., detached, semi-detached) having a Heating Ventilation and Air Conditioning (HVAC) system containing a condenser stationed outside the house (e.g., on a pad), a furnace stationed inside the house (e.g., in a basement), and a thermostat stationed inside the house (e.g., on a wall of a living room). The thermostat is connected (e.g., wired, wirelessly) to the condenser and the furnace to activate or deactivate the condenser or the furnace as needed. Therefore, over time, this cycle of operation requires the condenser or the furnace to be serviced (e.g., maintained) periodically (e.g., annually). Since servicing the condenser or the furnace may be complicated or laborious/time-consuming for the resident, a technician may be engaged by the resident to do so.

In order to service the condenser or the furnace, the technician typically adjusts various settings (e.g., temperature settings, humidity settings) on the thermostat to experience (e.g., see, hear, smell, feel) how the condenser or the furnace is reacting to such adjustments. Since the condenser is stationed outside the house, the technician may need to exit the house to access the condenser, which is not always desired due to environmental conditions (e.g., heat, humidity, rain, snow, hail, winds), ground conditions (e.g., dirt, sand, mud, snow, ice, water puddles, poison ivy, cactuses), privacy conditions (e.g., backyard, fencing), ongoing construction, or presence of animals (e.g., pets, wildlife). Additionally, if the thermostat is also wirelessly connected to a Wi-Fi access point (e.g., a Wi-Fi router, a Wi-Fi extender) secured with a password, or the thermostat is accessible with a user login, then the resident may object or not desire to sharing the password or the user login with the technician for privacy or security purposes. Additionally, when the condenser or the furnace needs to replaced or a new HVAC component (e.g., a humidifier, a dehumidifier, a heat pump) needs to be connected to the thermostat, in order for the technician to initially commission the thermostat for such scenarios, the technician may need to manually set the thermostat according to various configurations of the condenser or the furnace or the new HVAC component, which can be complicated, laborious/time-consuming to set, error prone, or be limited by the thermostat at hand, especially if the technician is wearing a pair of industrial gloves.

### SUMMARY

Broadly, this disclosure enables a system comprising a mobile computing terminal (e.g., a smartphone) having a first network interface (e.g., a Bluetooth chip) and a thermostat having a second network interface (e.g., a Bluetooth chip). The first network interface and the second network interface directly pair with each other such that the mobile computing terminal can be operated by a user (e.g., a technician) to push a preset or customized setting for an HVAC component (e.g., a condenser) onto the thermostat. Through such pairing, the mobile computing terminal may also control the thermostat or receive runtime data from the thermostat, which allows the user to test the preset or customized setting for the HVAC component. Therefore, the system enables the mobile computing terminal to directly configure or control the thermostat, without the mobile computing terminal needing to connect to a network intermediary (e.g., a Wi-Fi router, a Wi-Fi extender) to do so. Additionally, the system enables the user to minimize going outdoors during such configuration or control, thereby minimizing exposure to adverse, difficult or unsafe ground conditions. Note that this disclosure enables other technologies as well.

### DESCRIPTION OF DRAWINGS

FIG. 1 shows a set of screenshots of an example of a Graphical User Interface (GUI) of an application program operating in a technician mode and hosted on a mobile computing terminal enabling the mobile computing terminal to directly pair with a thermostat according to this disclosure.

FIG. 2 shows a set of screenshots of an example of a GUI of an application program operating in a technician mode and hosted on a mobile computing terminal enabling the mobile computing terminal to connect to a thermostat in a tech settings mode according to this disclosure.

FIG. 3 shows a set of screenshots of a GUI of an application program operating in a technician mode and hosted on a mobile computing terminal enabling the mobile computing terminal to select a wiring configuration from a set of wiring configurations for a set of HVAC components and push the wiring configuration to a thermostat according to this disclosure.

FIG. 4 shows a set of screenshots of a GUI of an application program operating in a technician mode and hosted on a mobile computing terminal enabling the mobile computing terminal to populate a form with a set of configuration parameters and push the set of configuration parameters to a thermostat according to this disclosure.

FIG. 5 shows an example of a wiring layout for a thermostat according to this disclosure.

FIG. 6 shows a schematic diagram of a thermostat directly pairing with a mobile computing terminal according to this disclosure.

FIG. 7 shows a set of screenshots of an example of a GUI of an application program operating in a technician mode and hosted on a mobile computing terminal enabling the mobile computing terminal to directly pair with a thermostat according to this disclosure.

FIG. 8 shows a set of screenshots of an example of a GUI of an application program operating in a technician mode and hosted on a mobile computing terminal enabling the mobile computing terminal to connect to a thermostat in a tech settings mode according to this disclosure.

FIG. 9 shows a set of screenshots of a GUI of an application program operating in a technician mode and hosted on a mobile computing terminal enabling the mobile computing terminal to select a wiring configuration from a set of wiring configurations for a set of HVAC components and push the wiring configuration to a thermostat according to this disclosure.

FIG. 10 shows a set of screenshots of a GUI of an application program operating in a technician mode and hosted on a mobile computing terminal enabling the mobile computing terminal to populate a form with a set of configuration parameters and push the set of configuration parameters to a thermostat according to this disclosure.

### DETAILED DESCRIPTION

As explained above, this disclosure solves various technical problems described above by enabling (1) an application program (e.g., a mobile app) capable of running on an operating system (e.g., iOS, Android, Windows, Unix, Linux) of a mobile computing terminal (e.g., a phone, a smartphone, a tablet computer, a laptop computer, a wearable computer, a headset computer, an eyewear computer) having a first network interface (e.g., radio, Wi-Fi, Li-Fi, Bluetooth, Zigbee, Matter, line-of-sight, infrared, wired, Universal Serial Bus (USB)) and (2) a thermostat having a second network interface (e.g., radio, Wi-Fi, Li-Fi, Bluetooth, Zigbee, Matter, line-of-sight, infrared, wired, USB), where the first network interface is pairable (e.g., directly) with the second network interface. The first network interface may be a chip, a circuit, a circuit board, or another suitable hardware logic. The second network interface may be a chip, a circuit, a circuit board, or another suitable hardware logic. For example, the first network interface can wirelessly and directly pair with the second network interface (e.g., via a standardized connection, a Bluetooth connection) when positioned within operating range of each other (e.g., within about 20 feet or less, 15 feet or less, 10 feet or less), whether within a line-of-sight (e.g., optical, infrared) or not within a line-of-sight (e.g., radio, radio-frequency (RF)). For example, the first network interface can wirelessly and directly pair with the second network interface via a Bluetooth connection, such as a Bluetooth Low Energy (BLE) connection.

The thermostat may be stationed inside a house (e.g., detached, semi-detached) or an apartment. The thermostat may be mounted (e.g., fastened, mated) on a plate attached (e.g., fastened, mated) to a wall (e.g., a sidewall) of a room (e.g., a living room, a dining room, a corridor). The thermostat may be connected (e.g., wired, wireless) to the condenser, the furnace, or another suitable component of the HVAC system (e.g., a heat pump). The thermostat may be powered by a mains electricity source (e.g., a line, a wire, a cable, a cord), although this configuration is not required and the thermostat may be powered by a battery, a capacitor, or another suitable energy store, which may be replaceable or rechargeable, whether by removal thereof for replacing or recharging or while remaining inside the thermostat, such as via a far-field wireless power receiver receiving a far-field wireless power signal from a far-field wireless power transmitter, where the thermostat hosts the far-field wireless power receiver.

The mobile computing terminal may be operated by a user, such as a technician when the technician visits the house or the apartment to service, install, or initially commission the furnace, the condenser, or another suitable component of the HVAC system (e.g., a heat pump). As such, when the application program is active on the mobile computing terminal, the application program has access (e.g., read, download) to an inventory of preset settings (e.g., a set of templates) for the furnace, the condenser, or another suitable component of the HVAC system. For example, the inventory of preset settings may be accessed by the application program storing the inventory of preset settings internally or downloading the inventory of preset settings from a server or an Application Programming Interface (API) remote to the mobile computing terminal and the thermostat, which may occur over a cellular connection, a Wi-Fi connection, a Li-Fi connection, or another suitable connection. For example, these preset settings may be configuration settings.

The inventory of settings may be a data file, which may be structured (e.g., a JSON file), delimited (e.g., a CSV file), unstructured (e.g., descriptive or natural text), or another suitable data format. The inventory of preset settings may be generic for the furnace, the condenser, or another suitable component of the HVAC system or specific (e.g., customized) by make, model, version (hardware or software), or configuration for the furnace, the condenser, or another suitable component of the HVAC system. For example, a preset setting may be a single selection for a terminal identifier or a controllable function (e.g., a temperature value, a temperature range, a humidity value, a humidity range, a terminal identifier, a valve property, a blower schedule, a fan schedule) of the furnace, the condenser, or another suitable component of the HVAC system, or the preset setting can be a set of selections for a set of terminal identifiers or controllable functions (e.g., a temperature value, a temperature range, a humidity value, a humidity range, a terminal identifier, a valve property, a blower schedule, a fan schedule) of the furnace, the condenser, or another suitable component of the HVAC system. As such, the application program has access to the inventory of preset settings for the furnace, the condenser, or another suitable component of the HVAC system that the thermostat is capable of controlling at that location (e.g., observation, based on inquiring the resident, scanning a barcode disposed on a component of the HVAC system, interrogating a Radio-Frequency Identification (RFID) tag disposed on a component of the HVAC system, or having a digital access to a list of equipment identifiers along with corresponding makes, models, versions, or configurations). Therefore, since the application program has a Graphical User Interface (GUI), the technician operates the GUI to select an appropriate preset setting from the inventory of preset settings for the furnace, the condenser, or another suitable component of the HVAC system that the thermostat is capable of controlling at that location (e.g., based on inquiring the resident, scanning a barcode disposed on a component of the HVAC system, interrogating an RFID tag disposed on a component of the HVAC system, or having a digital access to a list of equipment identifiers along with corresponding makes, models, versions, or configurations). For example, the GUI may present a software wizard having a single screen or a set of screens that are consecutive, where the screen or the set of screens present a set of user input elements (e.g., a dropdown menu, a text field, a dial, a knob, a radio button) and a set of labels corresponding to the set of user input elements, both respectively corresponding to a set of terminal identifiers or a set of controllable functions of the furnace, the condenser, or another suitable component of the HVAC system. For example, the set of user input elements and the set of labels may define a form or a questionnaire (e.g., static, dynamic, reflexive) for the technician to complete. For example, a user input element of the set of user input elements may be a dropdown menu selecting a range of temperatures for the condenser, and a label of the set of labels may be “Select a temperature range for your air conditioner”. As such, the GUI presents the software wizard for the technician who inputs a set of identifiers to select a make, a model, a version, or a configuration of the furnace, the condenser, or another suitable component of the HVAC system connected to the thermostat and then presents/guides the technician to select an appropriate set of settings for the thermostat to control the furnace, the condenser, or another suitable component of the HVAC system. Although these settings may not be permissioned for editing by the technician, this configuration is not required. Therefore, if desired, then the technician may edit (e.g., add, remove, amend) at least some of those settings, as appropriate. Alternatively, those settings may be completely custom created or through various templates, either of those can be saved for the software wizard to subsequently present at another house. For example, those settings may be created or suggested to be amended by or engagement with a language model (e.g., Copilot, Gemini, ChatGPT). Then, the technician operates the GUI to command the application program to send (e.g., push) those settings, whether as preset or edited, to the thermostat from the first network interface to the second interface (e.g., via a Bluetooth connection) such that the thermostat starts to operate according to those settings. The thermostat may be operated from the application program as long as the first network interface is able to communicate with the second interface (e.g., within an operative range) such that the mobile computing terminal operates as “a remote control” to the thermostat. For example, this control may include requesting (i) activation or deactivation of an HVAC component, (ii) adjustment of a desired temperature setting, (iii) an increase or a decrease of a fan speed setting, (iv) a modification of a compressor operational setting, (v) an energizing or de-energizing of a terminal, or other suitable form of control. This modality of operation as “a remote control” is independent of setting up of the thermostat, whether for servicing, upgrading, or initial commissioning. The thermostat may send (e.g., push) its runtime log (e.g., how long the furnace, the condenser, or another suitable component of the HVAC system ran over a certain period of time) to the application program when the first network interface is in communication with the second network interface (e.g., within an operative range) such that the application program can present the runtime information in a user-friendly manner to the technician, save the runtime log locally, or send the runtime log to a server (e.g., an API) remote from the computing terminal. The technician may unpair the application program or the mobile computing terminal from the thermostat when needed.

Various terminology used herein can imply direct or indirect, full or partial, temporary or permanent, action or inaction, individual or collective. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

Likewise, as used herein, a term “or” is intended to mean an inclusive “or” rather than an exclusive “or.” That is, unless specified otherwise, or clear from context, “X employs A or B” is intended to mean any of natural inclusive permutations. That is, if X employs A; X employs B; or X employs both A and B, then “X employs A or B” is satisfied under any of foregoing instances.

Similarly, as used herein, various singular forms “a,” “an” and “the” are intended to include various plural forms (e.g., two, three, four) as well, unless context clearly indicates otherwise. For example, a term “a” or “an” shall mean “one or more,” even though a phrase “one or more” is also used herein.

Moreover, terms “comprises,” “includes,” “contains,” “has,” or “comprising,” “including,” “containing,” or “having” (or any tenses thereof) when used in this specification, specify a presence of stated features, integers, steps, operations, elements, or components, but do not preclude a presence and/or addition of one or more other features, integers, steps, operations, elements, components, or groups thereof. Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

As used herein, relative terms such as “below,” “lower,” “above,” and “upper” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

Additionally, although terms first, second, and others can be used herein to describe various elements, components, regions, layers, subsets, diagrams, or sections, these elements, components, regions, layers, subsets, diagrams, or sections should not necessarily be limited by such terms. Rather, these terms are used to distinguish one element, component, region, layer, subset, diagram, or section from another element, component, region, layer, subset, diagram, or section. As such, a first element, component, region, layer, subset, diagram, or section discussed below could be termed a second element, component, region, layer, subset, diagram, or section without departing from this disclosure.

As used herein, a term “about” or “substantially” refers to a +/±10% variation from a nominal value/term. Such variation is always included in any given value/term provided herein, whether or not such variation is specifically referred thereto.

As used herein, a term “or others,” “combination”, “combinatory,” or “combinations thereof” refers to all permutations and combinations of listed items preceding that term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. Skilled persons understand that typically there is no limit on a number of items or terms in any combination, unless otherwise contextually apparent.

Features or functionality described with respect to certain examples may be combined or sub-combined in or with various examples in any permutational or combinatorial manner. Different aspects or elements of examples, as disclosed herein, may be combined or sub-combined in a similar manner. A skilled person will understand that typically there is no limit on a number of items or terms in any combination, unless otherwise contextually apparent

Some examples, whether individually or collectively, can be components of a larger system, where other procedures can take precedence over or otherwise modify their application. Additionally, a number of steps can be required before, after, or concurrently with examples, as disclosed herein. Note that any or all methods or processes, at least as disclosed herein, can be at least partially performed via at least one entity in any manner.

Some examples are described herein with reference to illustrations of idealized examples (and intermediate structures) of this disclosure. As such, variations from various illustrated shapes as a result, for example, of manufacturing techniques or tolerances, are to be expected. Thus, various examples should not be construed as necessarily limited to various particular shapes of regions illustrated herein, but are to include deviations in shapes that result, for example, from manufacturing.

Any or all elements, as disclosed herein, can be formed from a same, structurally continuous piece, such as being unitary or monolithic, or be separately manufactured or connected, such as being an assembly or modules. Any or all elements, as disclosed herein, can be manufactured via any manufacturing processes, whether additive manufacturing, subtractive manufacturing, or any other types of manufacturing. For example, some manufacturing processes include Three Dimensional (3D) printing, laser cutting, Computer Numerical Control (CNC) routing, milling, pressing, stamping, vacuum forming, hydroforming, injection molding, lithography, fastening, adhering, nailing, stapling, threading, and so forth.

Also, unless otherwise defined, all terms (including technical and scientific terms) used herein have the same meaning as commonly understood by one of ordinary skill in an art to which this disclosure belongs. As such, terms, such as those defined in commonly used dictionaries, should be interpreted as having a meaning that is consistent with their meaning in a context of a relevant art and should not be interpreted in an idealized or overly formal sense unless expressly so defined herein.

As explained above, when the first network interface is in direct communication (e.g., wireless) with the second network interface (e.g., via a standardized connection, a Bluetooth connection, a BLE connection), the application program running on the OS of the mobile computing terminal provides local control of the thermostat to the technician so that the technician can control the thermostat (e.g., via a standardized connection, a Bluetooth connection, a BLE connection) while in close proximity to thermostat or the furnace, the condenser, or another suitable component of the HVAC system, without needing for the technician to access the thermostat via a network intermediary (e.g., a Wi-Fi access point, a Wi-Fi router, a Wi-Fi extender), whether with or without the password, or using the user login of the resident to access the thermostat, i.e., no need for credentials to the network intermediary or the thermostat. For example, this control may include requesting (i) activation or deactivation of an HVAC component, (ii) adjustment of a desired temperature setting, (iii) an increase or a decrease of a fan speed setting, (iv) a modification of a compressor operational setting, (v) an energizing or de-energizing of a terminal, or other suitable form of control. This modality of operation may also be helpful with servicing, troubleshooting, upgrading, or initial commissioning of the furnace, the condenser, or another suitable component of the HVAC system. For example, the application program may have a technician mode and a resident mode, where the technician mode enables servicing, troubleshooting, or initial commissioning of the furnace, the condenser, or another suitable component of the HVAC system, whereas the resident mode enables daily use of the furnace, the condenser, or another suitable component of the HVAC system. The application program may enter the technician mode or the resident mode on user login, where one login exists for the technician and another login exists for the resident, as enforced via a policy server remote from the thermostat. Below is a set of screenshots from the application program, as exemplified on a smartphone having a touchscreen.

As explained above, when the first network interface is in direct communication (e.g., wireless) with the second network interface (e.g., via a standardized connection, a Bluetooth connection, a BLE connection), the application program running on the OS of the mobile computing terminal provides the technician with an ability to send (e.g., push) various settings (e.g., back menu “tech” settings) that are typically tedious and cryptic to enter for the user because of a lack of screen space or resolution to adequately describe a particular feature. Further, this modality of operation is also a much faster method of entering all relevant or needed configuration settings from one display.

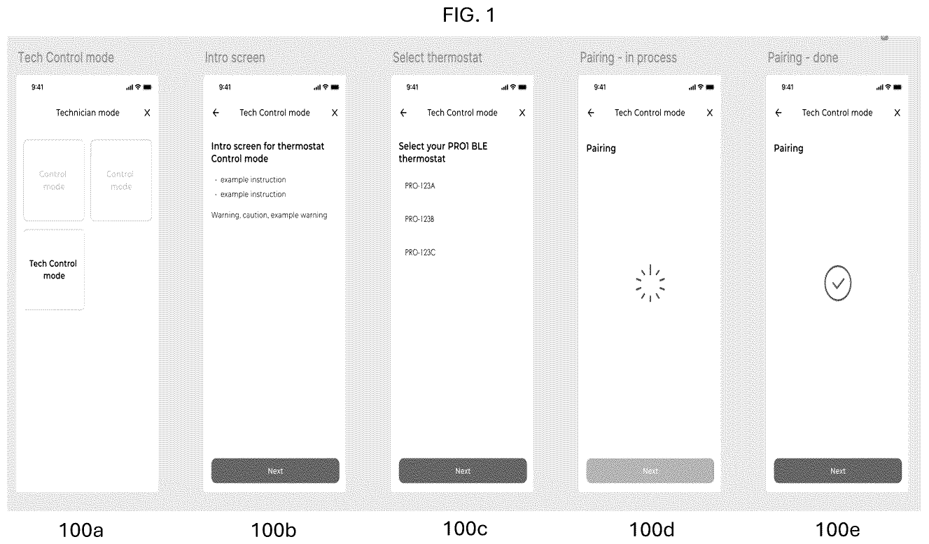

FIG. 1 shows a set of screenshots of an example of a GUI of an application program operating in a technician mode and hosted on a mobile computing terminal enabling the mobile computing terminal to directly pair with a thermostat according to this disclosure. In particular, there is a set of screenshots 100 including screenshots 100a to 100e, which are consecutive and collectively form at least a portion of the software wizard mentioned above. In screen 100a, the user (e.g., a technician) is enabled (e.g., guided) to select a tech control mode (see correspondingly named tile). In screen 100b, the user is presented with an introduction for entering the tech control mode (e.g., to manage expectations) and a button to proceed further (see next button) for user selection. In screen 100c, the user is presented with a menu presenting a set of thermostat identifiers (inside panes or other visual units) to select (e.g., by a touch input, a gesture) a thermostat identifier corresponding to the thermostat that the user would like to pair with the mobile computing terminal. The screen 100c also presents a button to proceed further (see next button) for user selection. In screen 100d, the user is presented with a graphic indicating that the mobile computing terminal and the thermostat are now directly pairing with each other (e.g., wirelessly). During this pairing process, the screen 100d shows a button to proceed further (see next button), but the button is now non-selectable or greyed out, to avoid interference with such pairing. In screen 100e, the user is presented with a graphic indicating that the mobile computing terminal and the thermostat are now successfully paired for a tech control mode, as explained above. The screen 100e presents a button to proceed further (see next button) for user selection.

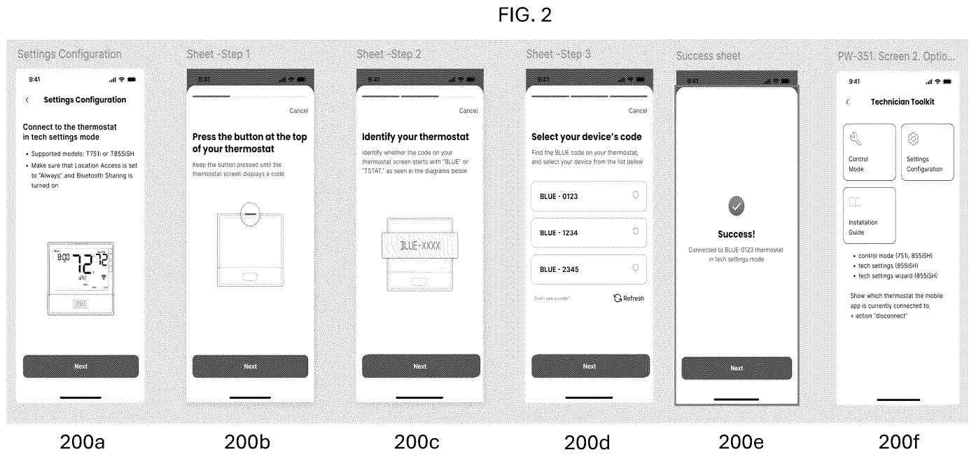

FIG. 2 shows a set of screenshots of an example of a GUI of an application program operating in a technician mode and hosted on a mobile computing terminal enabling the mobile computing terminal to connect to a thermostat in a tech settings mode according to this disclosure. In particular, there is a set of screenshots 200 including screenshots 200a to 200f, which are consecutive and collectively form at least a portion of the software wizard mentioned above. The set of screenshots 200 may or may not be consecutive (e.g., after or before) to the set of screenshots 100. Regardless, in screen 200a, the user (e.g., a technician) is provided with an introduction for a setting configuration (e.g., to manage expectations) and a button to proceed further (see next button) for user selection. In screen 200b, the user is instructed to physically engage or interface with the thermostat (e.g., for security purposes). For example, if the thermostat has a physical button, then such engagement or interfacing is manifested as pressing the button, which may be on top of the thermostat or another location (e.g., back, side, corner), and keeping the button pressed until the thermostat displays a code visual content (e.g., an alphanumeric string, a barcode, a QR code, an image) or emits a code audio content (e.g., a voice command, an alphanumeric string), for authentication purposes. The physical engagement may cease when the code visual content or the code audio content is output. The screen 200b also presents a button to proceed further (see next button) for user selection, once the code visual content or the code audio content is output on the thermostat. In screen 200c, the user is presented with an instruction. In screen 200c, the user is presented with an instruction to identify whether the visual code content or the audio code content output from the thermostat starts with or matches a predefined string (e.g., BLUE or STAT), as exemplified in a graphic below the instruction. The screen 200c also presents a button to proceed further (see next button) for user selection. In screen 200d, the user is presented with a menu presenting a set of thermostat identifiers (inside panes or other visual units) to select (e.g., by a touch input, a gesture) a thermostat identifier corresponding to the thermostat that the user would like to pair with the mobile computing terminal. The screen 200d also presents a button to proceed further (see next button) for user selection. The screen 200d also presents a refresh graphic to enable the application to refresh at least the set of thermostat identifiers, although the refresh graphic may be omitted. In screen 200e, the user is presented with a graphic indicating that the mobile computing terminal and the thermostat are now directly pairing with each other (e.g., wirelessly), for a settings configuration mode and a control mode, as explained above. The screen 200e also presents a button to proceed further (see next button) for user selection. In screen 200f, the user is presented with a menu for the settings configuration mode, the control mode, and a presentation of an installation guide. The menu is presented as a set of tiles, but this configuration is not required and other visual units may be presented. For example, the menu can be presented as a carousel, a set of radio buttons, a dropdown menu, or other forms of visual presentation.

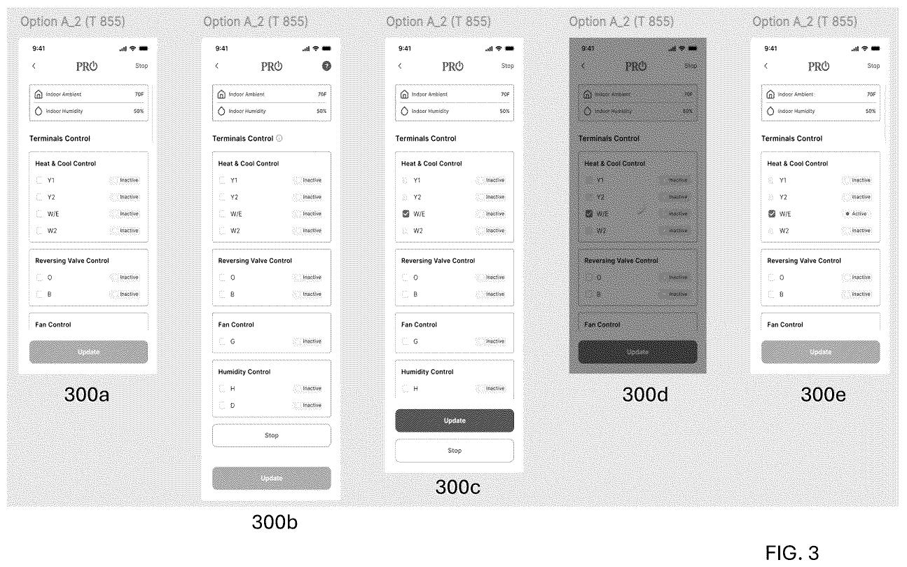

FIG. 3 shows a set of screenshots of a GUI of an application program operating in a technician mode and hosted on a mobile computing terminal enabling the mobile computing terminal to select a wiring configuration from a set of wiring configurations for a set of HVAC components and push the wiring configuration to a thermostat according to this disclosure. In particular, there is a set of screenshots 300 including screenshots 300a to 300e, which are consecutive and collectively form at least a portion of the software wizard mentioned above. The set of screenshots 300 may or may not be consecutive (e.g., after or before) to the set of screenshots 100 or the set of screenshots 200. Regardless, screen 300a shows a portion of a form or a questionnaire having a set of fields to populate by the user, as described above. For example, only one field can be populated or multiple fields can be populated. Regardless, the set of fields is organized a set of groups corresponding to a set of possible HVAC component categories. The set of fields corresponds to a corresponding set of operational values for that respective HVAC component. Adjacent (to right but can be somewhere else) to the set of fields is a set of visual indicators (e.g., color coded labels) visually informing (e.g., white versus green, red versus green) the user as to whether a respective field has been selected by the user and active within the thermostat, as communicated by the thermostat. Each of such visual indicators is binary (active or inactive), but this configuration is not required and other forms of visual presentation are possible. For example, there can be visual binary toggles, dials, knobs, dropdown menus, or other suitable forms of visual presentation. The screen 300a also presents a button to push (see update button) a selected operational value to the thermostat, as described above. Since the screen 300a may present many groups, there may not be enough viewport area to present all groups of the set of groups corresponding to the set of possible HVAC component categories. Therefore, screen 300b presents other groups not shown in the screen 300a. The screen 300b also has the button to push the selected operational value to the thermostat, but also has a button to stop or initiate stop this operation (see stop button as well) or exit the software wizard, in case of emergency or wrong operation value being selected. To minimize user confusion and maximize clarity these two buttons have different visual appearance (e.g., by color coding, fill, perimeter, font type, font size, wording), although this configuration is not required. Since no selection has been made on the screen 300b, note that the button to push is not selectable or greyed out, to minimize accidental pushing. However, in screen 300c, W/E selection has been made but not yet pushed from the mobile computing terminal to the thermostat. As such, the button to push is now selectable or not greyed, to enable the user to press such button and push the W/E selection from the mobile computing terminal to the thermostat, as described above. Once this button is pressed, screen 300d is presented and greyed out to indicate that the W/E selection is now being pushed from the mobile computing terminal to the thermostat, as described above. Once this operation is complete, screen 300e is presented to again (e.g., iteratively) show the form or the questionnaire of the screenshots 300a or 300b, but with an appropriate selection now being shown as selected and visually indicated to be active by a corresponding visual indicator (e.g., active label that is color coded to be green or another suitable visually distinct color), which may be based on receiving confirming information by the mobile computing terminal from the thermostat during direct pairing, as described above. Note that the button to push is again not selectable or greyed out, to minimize accidental pushing as described above. Likewise, the screen 300e also has the button to stop or initiate stop this operation (see stop button as well) or exit the software wizard, in case of emergency or wrong operation value being selected. To minimize user confusion and maximize clarity these two buttons have different visual appearance (e.g., by color coding, fill, perimeter, font type, font size, wording), although this configuration is not required. For example, the screen 300e may be the screen 300a or the screen 300b.

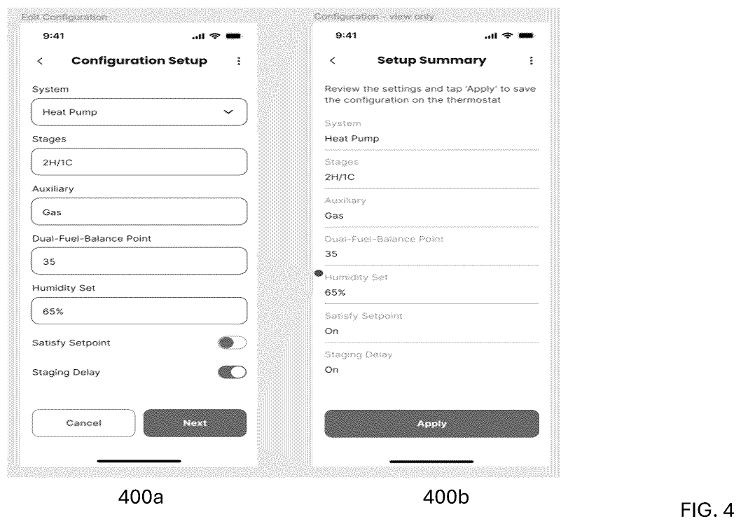

FIG. 4 shows a set of screenshots of a GUI of an application program operating in a technician mode and hosted on a mobile computing terminal enabling the mobile computing terminal to populate a form with a set of configuration parameters and push the set of configuration parameters to a thermostat according to this disclosure. In particular, a set of screenshots 400 has a screenshot 400a and a screenshot 400b, which are consecutive and collectively form at least a portion of the software wizard mentioned above. The set of screenshots 400 may or may not be consecutive (e.g., after or before) to the set of screenshots 100, the set of screenshots 200, or the set of screenshots 300. Regardless, the screen 400a shows a form or a questionnaire for population by the user for an HVAC component, as described above. Note that the form or the questionnaire have different types of input fields (e.g., text fields, binary toggles), although this configuration is not required and the form or the questionnaire may have one type of input fields. The screen 400a also presents a next button to move to screen 400b or a cancel button cancel the software wizard. Similar to above, the next button and the cancel button are presented to be visually distinct. In the screen 400b, there is a presentation of configuration parameters immediately before the user selects an apply button to initiate a push of such configuration parameters from the mobile computing terminal to the thermostat when directly paired with each other, as described above. In situations where a certain configuration parameter in inconsistent, inappropriate or forecasted not to work or disable an HVAC component, then the screen 400b may present a visual indicator adjacent to a field containing such value. As shown in the screen 400b, the visual indicator is a red dot, but other suitable color-coding schemes, graphics or forms of notification are possible (e.g., highlight a field, overlay a bounding box over a field).

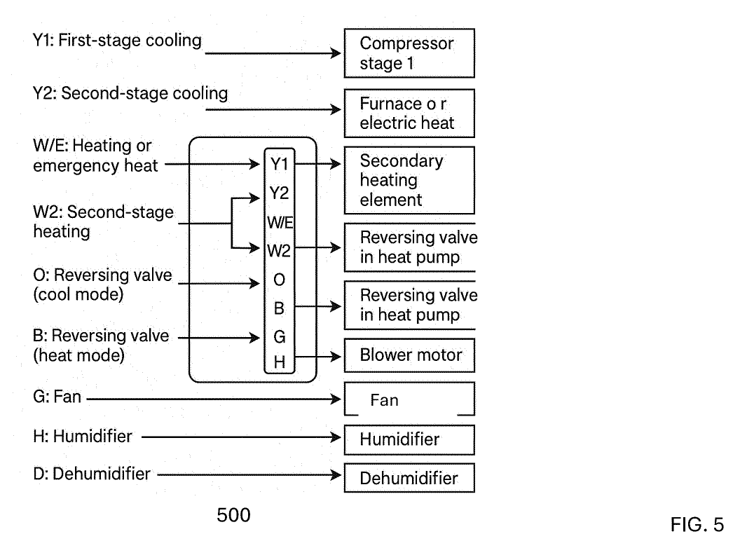

FIG. 5 shows an example of a wiring layout for a thermostat according to this disclosure. In particular there is a wiring layout 500 that may be used for configuring the thermostat, as described above.

There may be Heat & Cool Control settings (e.g., parameters) where Y1 is the terminal for the first stage of cooling. When the thermostat calls for cooling, it sends a signal through Y1 to activate the air conditioning system. Y2 is used for the second stage of cooling in systems that support two-stage cooling. It provides enhanced cooling performance during high demand. W/E serves a dual purpose: it controls the primary heating source in standard systems and acts as the emergency heat trigger in heat pump systems. W2 is the second stage heating terminal, used in multi-stage heating systems to provide additional heat when the first stage (W/E) is insufficient.

There may be Reversing Valve Control settings (e.g., parameters) where O and B terminals are specific to heat pump systems. The O terminal energizes the reversing valve to switch the system into cooling mode, while the B terminal energizes it for heating mode. Only one of these is used depending on the heat pump's design.

There may be Fan Control settings (e.g., parameters) where G controls the system fan. It can be activated independently of heating or cooling to circulate air, either continuously or based on system demand.

There may be Humidity Control settings (e.g., parameters) where H is used to control a humidifier, adding moisture to the air when indoor humidity is too low.

There may be Dehumidifier Control settings (e.g., parameters) where D controls a dehumidifier, removing excess moisture when indoor humidity is too high.

These wiring configurations are important because they determine how the thermostat communicates with the HVAC component to respectively control heating, cooling, fan operation, and humidity. Each wire corresponds to a specific function—like activating the compressor, switching the reversing valve, or turning on a humidifier. If these are misconfigured, then the HVAC component respectively might not heat or cool properly, could run inefficiently, or even become damaged. Updating these settings is necessary whenever a thermostat is installed, replaced, or connected to a different HVAC system. Different systems (e.g., single-stage vs. multi-stage, conventional vs. heat pump) require different wiring logic. For example, a heat pump might use the O terminal for cooling mode, while another might use B for heating mode. Getting this wrong could reverse the system's behavior. Therefore, using the application program to update these settings offers several technical advantages. For example, some of these advantages include speed and convenience whereby installers can configure the thermostat without navigating tiny screens or physical buttons. Further, some of these advantages include accuracy whereby the application program can guide users through system-specific wiring logic, reducing errors. Additionally, some of these advantages include remote updates whereby settings can be pushed wirelessly, which is especially helpful in tight or hard-to-access installations. Additionally, some of these advantages include diagnostics and validation whereby the application program can verify wiring and system compatibility before finalizing the configuration. These technical advantages may be useful when for example, during initial commissioning, the technician must configure these based on whether the system is single-stage or multi-stage, and whether it's a heat pump or conventional system. Likewise, these technical advantages may be useful when for example during maintenance, updates may be needed if the HVAC component is upgraded (e.g., from single-stage to two-stage), or if components like the furnace or compressor are replaced. Similarly, these technical advantages may be useful when for example during initial setup, the installer must select either O or B based on the heat pump manufacturer's design. Moreover, these technical advantages may be useful when for example during maintenance, this setting may need to change if the heat pump unit is replaced with one that uses the opposite logic. Further, these technical advantages may be useful when for example during commissioning, the fan control mode (auto vs always-on) may be configured. Likewise, these technical advantages may be useful when for example during maintenance, updates may be needed if the fan relay is replaced or if the system is reconfigured for continuous ventilation. Similarly, these technical advantages may be useful when for example during initial setup, these terminals are configured only if a humidifier or dehumidifier is installed. Moreover, these technical advantages may be useful when for example during maintenance, updates may be required if humidity control equipment is added, removed, or replaced. As such, using the application program to update these settings streamlines the process, reduces human error, and allows for faster, more accurate configuration, while enabling real-time validation of wiring and compatibility, remote diagnostics and updates without navigating small thermostat screens, and consistency across multiple installations in commercial or multi-unit residential settings.

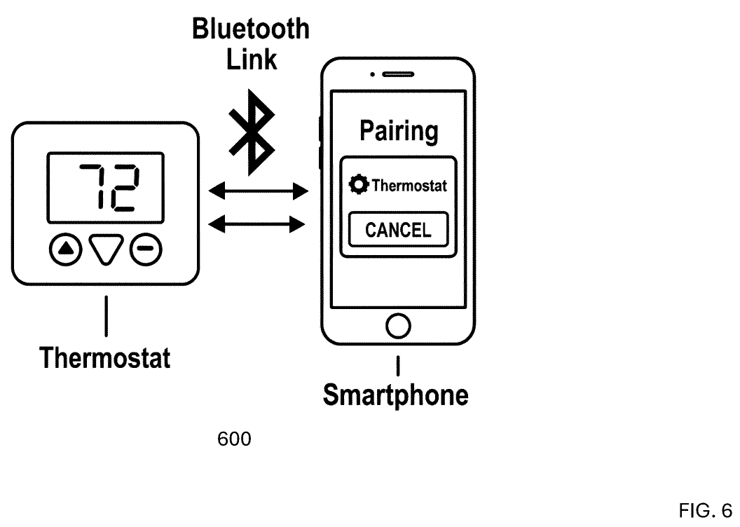

FIG. 6 shows a schematic diagram of a thermostat directly pairing with a mobile computing terminal according to this disclosure. In particular, there is a topology for a Personal Area Network (PAN) enabled by a wireless connection, which may be a Bluetooth connection, a BLE connection, or another suitable wireless connection, whether in line-of-sight or outside line-of-sight. As describe above, the application program shown in the set of screenshots 100, the set of screenshots 200, the set of screenshots 300, the set of screenshots 400 is designed to pair with the thermostat via a direction pairing (e.g., a Bluetooth connection) with the mobile computing terminal, thereby enabling the user to configure various HVAC wiring and push settings directly from the mobile computing terminal, as described above. The set of screenshots 100, the set of screenshots 200, the set of screenshots 300, and the set of screenshots 400 provide control over several key thermostat terminals, each corresponding to specific HVAC functions.

As shown above, each screenshot in the app reflects different wiring configurations and allows the user to update the thermostat settings accordingly, streamlining the installation and setup process. For example, the technician may begin an initial commissioning, maintenance, repair, or upgrade process by using his own mobile computing terminal (e.g., a smartphone, a tablet computer, a wearable computer) and a profile account (e.g., a Google account). The technician launches the application program (e.g., a Google Home mobile app) in the technician mode (e.g., a pro mode), which may only be accessible to authorized installers or through specific methods, such as scanning a barcode or a QR code found on a thermostat package (e.g., a box, a sticker). In this mode, the technician performs an offline configuration of the thermostat. The thermostat directly pairs with the mobile computing terminal, as described above, thereby eliminating any need for a Wi-Fi connection during this stage. Through the application program, the technician may configure various system settings (e.g., parameters), including a HVAC system type (e.g., a heat pump unit, a forced air unit, an electric unit, a mini-split unit), wire mapping and terminal functions, and equipment settings like fan control and fuel source. The technician may also set preferences such as temperature scale (e.g., Fahrenheit, Celsius, Kelvin) and language as needed. Since this process is done locally, the technician is provided with a streamlined and efficient process without requiring internet access (e.g., Wi-Fi access), as described above.

Therefore, based on above, this disclosure enables the technician to directly pair (e.g., wirelessly) the mobile computing terminal with the thermostat and configure operational settings through the application program operating in the technician mode. As exemplified above, the application program runs in the technician mode on the operating system of the mobile computing terminal (e.g., a smartphone). The mobile computing terminal includes the display and the first network interface. In the technician mode, the application program enables the first network interface to directly pair with the second network interface of the thermostat. The thermostat is operatively connected to at least one component (e.g., a condenser, a furnace) of the HVAC system. The pairing may occur over the wireless connection, which may be a radio connection, such as a Bluetooth connection, and more specifically, a Bluetooth Low Energy (BLE) connection, although these are examples. Once paired, the display of the mobile computing terminal presents the GUI rendered (or passed through if a browser) by the application program. The GUI enables the technician to select one or more settings for the HVAC component. These settings may include, but are not limited to, wiring configurations and configuration parameters such as system type (e.g., heat pump, forced air, electric), fan control behavior, fuel source, temperature scale (Fahrenheit or Celsius), and language preferences. After the technician selects a setting, the application program sends the setting from the mobile computing terminal to the thermostat via the first and second network interfaces. The thermostat then operates the HVAC component according to the received setting. The GUI may further enable the technician to control the thermostat in real time from the mobile computing terminal while the application program continues to run in the technician mode. For example, this control may include requesting (i) activation or deactivation of an HVAC component, (ii) adjustment of a desired temperature setting, (iii) an increase or a decrease of a fan speed setting, (iv) a modification of a compressor operational setting, (v) an energizing or de-energizing of a terminal, or other suitable form of control. This allows the technician to test the operation of the HVAC component based on the selected setting, thereby verifying correct installation and configuration without requiring a Wi-Fi or cloud connection. The mobile computing terminal may be a phone, a smartphone, a tablet computer, a wearable computer, or another suitable computing terminal. The application program may include both the technician mode and the resident mode. Access to the technician mode may be restricted for safety purposes and may be granted based on preauthorization. The mobile computing terminal may include a camera, and the application program may activate the technician mode upon receiving a barcode, such as a Quick Response (QR) code, captured by the camera. The barcode may be disposed on the thermostat itself or on its packaging. As described above, to facilitate configuration, the application program may include the software wizard that presents the GUI as a series of guided steps or screens. The technician selects the desired setting through the wizard, and the wizard commands the mobile computing terminal to transmit the setting to the thermostat. This structured workflow ensures accuracy and efficiency during installation and setup. This technology provides a secure, local, and streamlined approach for HVAC professionals to configure thermostats without requiring internet connectivity, thereby improving installation speed, reducing errors, and enhancing field service capabilities.

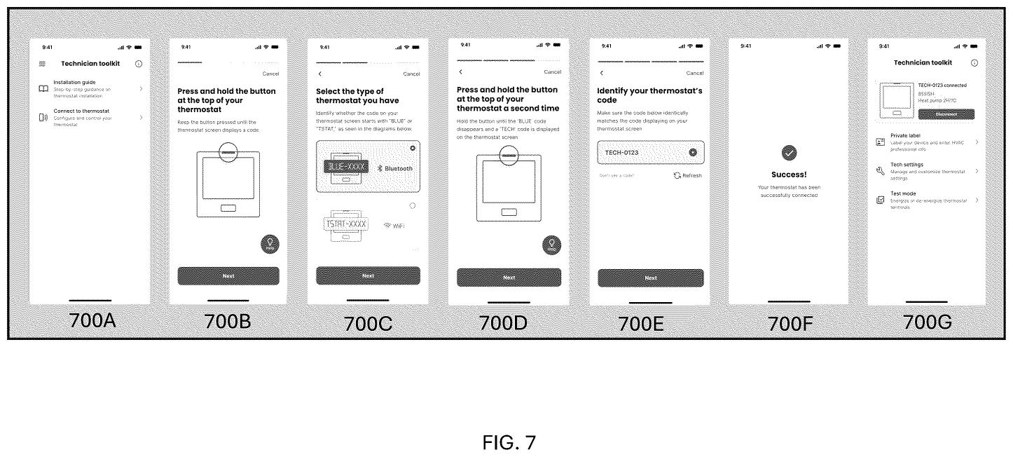

FIG. 7 shows a set of screenshots of an example of a GUI of an application program operating in a technician mode and hosted on a mobile computing terminal enabling the mobile computing terminal to directly pair with a thermostat according to this disclosure. In particular, alternative or additional to the set of screenshots 100 illustrated in FIG. 1, there is a set of screenshots 700 including screenshots 700A to 700G, which are consecutive and collectively form at least a portion of the software wizard mentioned above. As such, the user may access the technician mode by the mobile computing terminal displaying the screen 700A showing a description to inform the user of the implications of using the feature and an option user input element (e.g., a virtual button, a dropdown menu, a hyperlink, a graphic) to proceed. If the user activates the option input element to proceed, then the screen 700B presents an instructional content directing the user on what action to initiate on the thermostat, along with a corresponding user input element (e.g., a virtual button, a dropdown menu, a hyperlink, a graphic) to proceed to next screen. If the user confirms that the user has taken the action on the thermostat by activating the corresponding user input element, then the screen 700C presents a decisional content for the user to choose which type of thermostat the user is interacting with (e.g., what thermostat is the user facing), along with a corresponding user input element (e.g., a virtual button, a dropdown menu, a hyperlink, a graphic) to proceed to next screen. Once the selects the thermostat type presented in the screen 700C, the user activates the corresponding user input element to proceed to next screen. Then, the screen 700D is presented with an instructional content to direct the user to take a second action on the thermostat, along with a corresponding user input element (e.g., a virtual button, a dropdown menu, a hyperlink, a graphic) to proceed to next screen. Once the user takes the second action, the user activates the corresponding user input element to proceed to next screen. Then, the screen 700E presents an authentication code to verify the mobile computing terminal is connecting to the correct thermostat against the authentication code contemporaneously presented on the thermostat. The screen 700E also presents a corresponding user input element (e.g., a virtual button, a dropdown menu, a hyperlink, a graphic) to proceed to next screen. Once the user verifies the authentication code on the screen 700E against the authentication code contemporaneously presented on the thermostat, the user activates the corresponding user input element to proceed to next screen. Then, the screen 700F presents a confirmation content (e.g., text, graphics) confirming the mobile computing terminal has successfully connected to the thermostat by direct pairing, as disclosed herein. Then, the screen 700G presents a set of options corresponding to a set of user input elements (e.g., a virtual button, a dropdown menu, a hyperlink, a graphic) for the user to activate on the screen 700G to initiate a corresponding set of software wizards available now that the user has entered technician mode. Likewise, the screen 700G shows a user input element (e.g., a virtual button, a dropdown menu, a hyperlink, a graphic) to initiate disconnection from the thermostat, as disclosed herein. The set of screenshots 700 may differ from the set of screenshots 100 in that the set of screenshots 700 enables the option to choose between Bluetooth and Wi-Fi thermostat models and an additional step to press the user input element (e.g., a virtual button, a dropdown menu, a hyperlink, a graphic) on the thermostat a second time, which starts a 2nd Bluetooth (e.g., BLE) service specific to the technician mode.

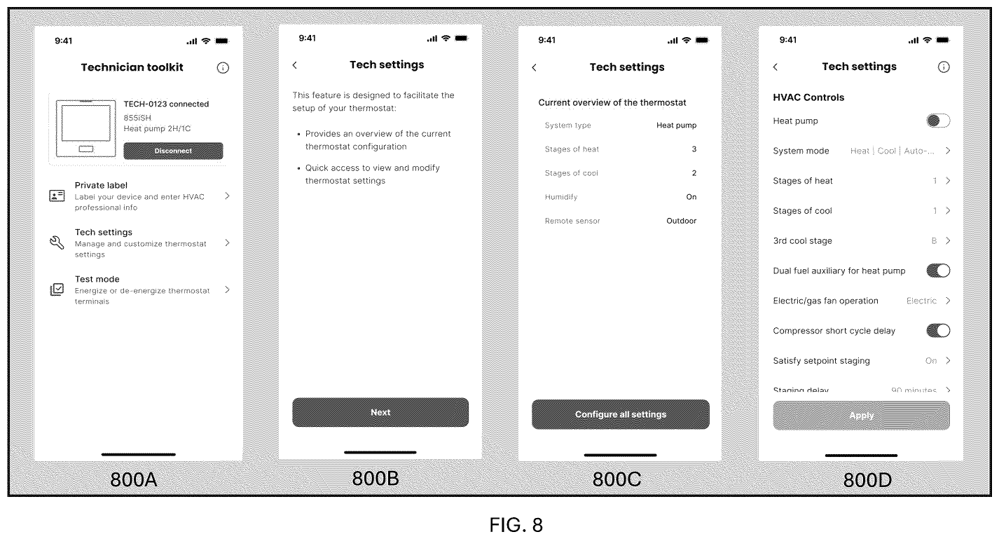

FIG. 8 shows a set of screenshots of an example of a GUI of an application program operating in a technician mode and hosted on a mobile computing terminal enabling the mobile computing terminal to connect to a thermostat in a tech settings mode according to this disclosure. In particular, alternative or additional to the set of screenshots 200 illustrated in FIG. 2, there is a set of screenshots 800 including screenshots 800A to 800D, which are consecutive and collectively form at least a portion of the software wizard mentioned above. As such, the user may access a technician toolkit selection mode by the mobile computing terminal displaying the screen 800A which allows the user to exit the tech mode in the main menu of the technician tool kit selection screen by activating a corresponding user input element (e.g., a virtual button, a dropdown menu, a hyperlink, a graphic). Note that the screen 700G and the screen 800A may be one screen. Therefore, when the user selects a technician toolkit feature by activating a corresponding user input element (e.g., a virtual button, a dropdown menu, a hyperlink, a graphic), the screen 800B presents a description of the feature before access to the feature is granted, along with a corresponding user input element (e.g., a virtual button, a dropdown menu, a hyperlink, a graphic) to proceed to next screen. When the user proceeds by activating the corresponding user input element presented on the screen 800B, the user is guided to the screen 800C presenting an overview or a snapshot of current settings, along with a corresponding user input element (e.g., a virtual button, a dropdown menu, a hyperlink, a graphic) to proceed to next screen to configure some, many, most, or all current settings, at least some of which are presented on the screen 800C. Once the user activates the corresponding user input element presented on the screen 800C, the user is presented with the screen 800D which presents a form or a questionnaire for the user to edit or complete for the tech setting features and then send (e.g., push) to the thermostat, as disclosed herein, by activating a corresponding user input element (e.g., a virtual button, a dropdown menu, a hyperlink, a graphic). As such, the set of screenshots 800 provides a fast way to exit the feature and return to normal operation, while also providing information to the user about the feature the user is about to use.

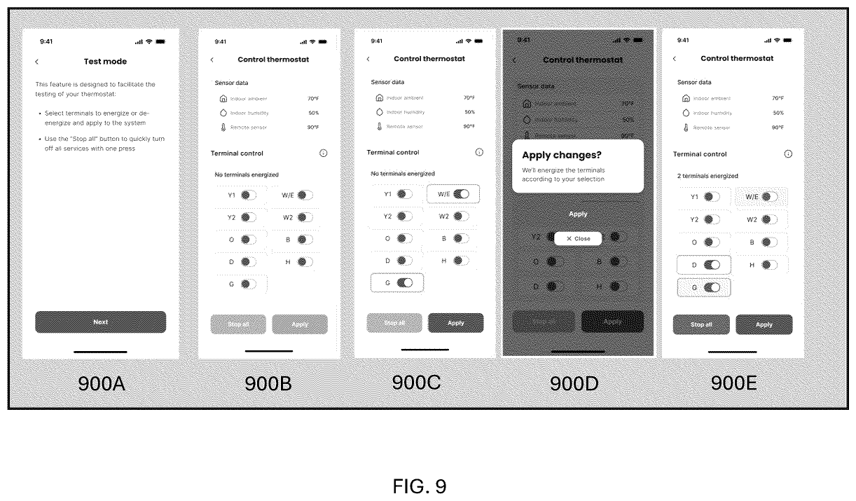

FIG. 9 shows a set of screenshots of a GUI of an application program operating in a technician mode and hosted on a mobile computing terminal enabling the mobile computing terminal to select a wiring configuration from a set of wiring configurations for a set of HVAC components and push the wiring configuration to a thermostat according to this disclosure. In particular, alternative or additional to the set of screenshots 300 illustrated in FIG. 3, there is a set of screenshots 900 including screenshots 900A to 900E, which are consecutive and collectively form at least a portion of the software wizard mentioned above. As such, the user may access the test mode by the screen 900A being presented to show a description to inform the user of the implications of using the feature, along with a corresponding user input element (e.g., a virtual button, a dropdown menu, a hyperlink, a graphic) to proceed to next screen. If the user activates the corresponding user input element, then the screen 900B is presented presents some, many, most, or all possible control options in a single view, whether in a default control view, a recommended control view, or a current control view. Although these controls are shown as binary toggles, this configuration is not required and other user input elements are possible (e.g., dropdown menus, tabs). The screen 900B also shows a stop user input element (e.g., a virtual button, a dropdown menu, a hyperlink, a graphic) to request stoppage of selected control options being pushed to the thermostat and an apply user input element (e.g., a virtual button, a dropdown menu, a hyperlink, a graphic) to request application of selected control options being pushed to the thermostat. Once the user activates the desired control options as shown in the screen 900C, the activates the stop user input element or the apply user input element as needed. Therefore, when the user makes a terminal control selection shown in the screen 900C, a preview of the action is automatically generated as in the screen 900C. To activate the changes, the user must press the apply user input element and the screen 900D shows a warning to verify the user is ready for the change, along with a confirmation user input element (e.g., a virtual button, a dropdown menu, a hyperlink, a graphic) to confirm application of those controls and along with a close user input element (e.g., a virtual button, a dropdown menu, a hyperlink, a graphic) to go back to the screen 900C. Note that the screen 900D presents a preview of what control settings will be applied to the thermostat, once the corresponding user input element is activated. Once the user activates the confirmation user input element in the screen 900D, the user is presented with the screen 900E which shows the effect of applying their desired changes and the active state of the thermostat. Note that some control options may be made visually distinct when activate based on the confirmation user input being selected. For example, this form of visual distinction may be exemplified by color coding those controls (or unselected controls) whether by background, text, font, size, bounding boxes, or other suitable forms of visual highlighting. If those control options are presented not as binary toggles, then those controls options may also be made visually distinct when activate based on the confirmation user input being selected. As such, the set of screenshots 900A to 900E may differ from the set of screenshots 300 including larger indicators of the state of the HVAC system and a consolidated view that eliminates the need to scroll on the control device to see all available options.

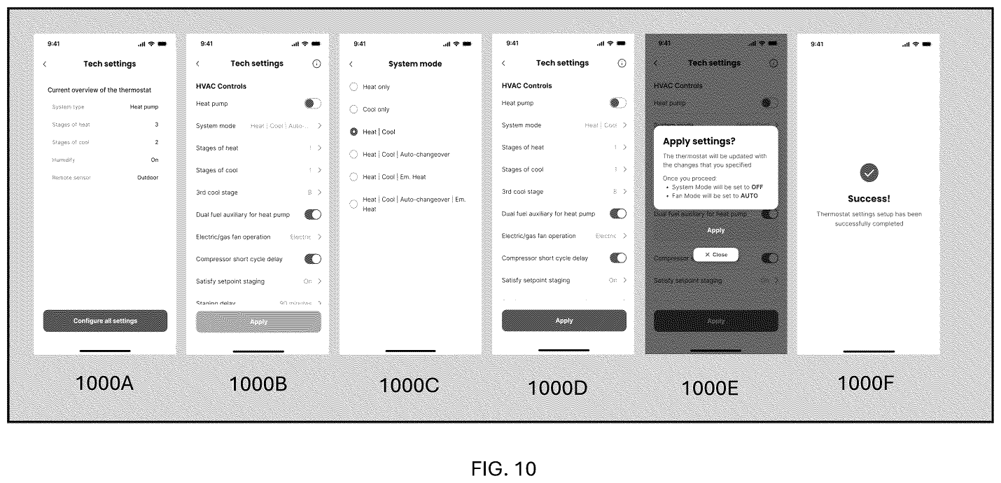

FIG. 10 shows a set of screenshots of a GUI of an application program operating in a technician mode and hosted on a mobile computing terminal enabling the mobile computing terminal to populate a form with a set of configuration parameters and push the set of configuration parameters to a thermostat according to this disclosure. In particular, alternative or additional to the set of screenshots 400 illustrated in FIG. 4, there is a set of screenshots 1000A to 1000F, which are consecutive and collectively form at least a portion of the software wizard mentioned above. As such, the user may implement a tech settings mode by presenting the screen 1000A showing a current overview of active settings in the thermostat, along with a corresponding user input element (e.g., a virtual button, a dropdown menu, a hyperlink, a graphic) to proceed to next screen to configured some, many, most, or all of those settings. The user proceeds by activating the corresponding user input element in the screen 1000A to present the screen 1000B showing a scrollable menu of tech settings, with each setting have its own user input element (e.g., a binary toggle, a graphic, a virtual button), whether to activate/deactivate that setting on that screen, enter an alphanumeric value on that screen, or present another screen, menu, or form (for more complex use cases). For example, selecting a tech setting on the screen 1000B that is more complex to modify than a binary toggle or a text box, the screen 1000C is presented with a configuration menu, which presents more user input elements (e.g., radio buttons, dropdown menus, binary toggles, text boxes) to the user to select. Note that each such configuration screen may be unique to the tech setting options presented in the screen 1000B. Regardless, once the screen 1000C is configured, the updated view is presented to the user in a scrolling menu as in the screen 1000D, where the user can iterate as needed similar to the screen 1000B until the user is satisfied that all desired edits to the settings have been made. If the user is ready to apply those settings to the thermostat, then the user is presented with a confirmation screen 1000E similar to the screen 900D (similar user input elements) and a validation screen 1000F if the tech setting update was successful. Note that the screen 1000E presents a preview of what tech settings will be applied to the thermostat, once the corresponding user input element is activated. The update may fail if the thermostat determines the user attempted to load an invalid configuration. As such, the set of screenshots 1000A to 1000E provides a safety feature to ensure an invalid state was not selected. The user is presented with options to confirm their choices and the effect of changing tech settings on the operation of the thermostat.

Various examples of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to be-come coupled to other data processing systems or remote printers or storage devices through intervening private or public networks. Modems, cable modems, and Ethernet cards are just a few of the available types of network adapters.

This disclosure may be exemplified in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a port-able compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network, a neutrino network, an optical network (e.g., Li-Fi, fiberoptics), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of this disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the examples disclosed herein may be implemented as electronic hardware, computer soft-ware, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Features or functionality described with respect to certain example examples may be combined and sub-combined in and/or with various other example examples. Also, different aspects and/or elements of example examples, as dis-closed herein, may be combined and sub-combined in a similar manner as well. Further, some example examples, whether individually and/or collectively, may be components of a larger system, wherein other procedures may take precedence over and/or otherwise modify their application. Additionally, a number of steps may be required be-fore, after, and/or concurrently with example examples, as disclosed herein. Note that any and/or all methods and/or processes, at least as disclosed herein, can be at least partially performed via at least one entity or actor in any manner.

Although preferred examples have been depicted and described in detail herein, skilled persons know that various modifications, additions, substitutions and the like can be made without departing from spirit of this disclosure. As such, these are considered to be within the scope of the disclosure, as defined in the following claims.

What is claimed is:

1. A method, comprising:
causing an application program to run in a technician mode on an operating system of a mobile computing terminal having a display and a first network interface such that (1) the first network interface directly pairs with a second network interface of a thermostat connected to a component of an HVAC system and (2) the display displays a Graphical User Interface (GUI) that enables a technician to (i) select a setting for the component and (ii) send the setting from the application program via the first network interface to the thermostat via the second network interface such that the thermostat operates the component according to the setting.

2. The method of claim 1, wherein the first network interface directly pairs with the second network interface over a wireless connection.

3. The method of claim 2, wherein the wireless connection is a radio connection.

4. The method of claim 3, wherein the wireless connection is a Bluetooth connection.

5. The method of claim 4, wherein the Bluetooth connection is a Bluetooth Low Energy (BLE) connection.

6. The method of claim 1, wherein the GUI enables the technician to control the thermostat from the mobile computing terminal as the application program runs in the technician mode after the setting is sent from the mobile computing terminal to the thermostat while the first network interface is directly paired with the second network interface such that the technician can test how the component is operating based on the setting.

7. The method of claim 6, wherein the GUI enables the technician to control the thermostat from the mobile computing terminal by presenting a user input element corresponding to a selection of a terminal for the component of an HVAC system to energize or deenergize and enabling the user input element to be activated or deactivated by the technician.

8. The method of claim 1, wherein the mobile computing terminal is a wearable computer.

9. The method of claim 1, wherein the application program has the technician mode and a resident mode, wherein the technician mode is accessible to the technician based on the technician being preauthorized to access the technician mode.

10. The method of claim 1, wherein the mobile computing terminal has a camera, wherein the application program has the technician mode and a resident mode, wherein the technician mode is accessible to the technician based on the application program receiving a barcode captured from the camera being activated by the application program.

11. The method of claim 10, wherein the barcode is a Quick Response (QR) code.

12. The method of claim 10, wherein the barcode is disposed or displayed on the thermostat.

13. The method of claim 10, wherein the barcode is disposed or displayed on a package for the thermostat.

14. The method of claim 1, wherein the setting is a wiring configuration.

15. The method of claim 1, wherein the setting is a configuration parameter.

16. The method of claim 1, wherein the application program has a software wizard presenting the GUI as a series of steps or screens such that the setting is selected via the software wizard and the setting is commanded to be sent from the mobile computing terminal to the thermostat via the software wizard.

17. A method, comprising:
running, by a processor, an application program in a technician mode on an operating system of a mobile computing terminal having a display and a first network interface such that (1) the first network interface directly pairs with a second network interface of a thermostat connected to a component of an HVAC system and (2) the display displays a Graphical User Interface (GUI) that enables a technician to (i) select a setting for the component and (ii) send the setting from the application program via the first network interface to the thermostat via the second network interface such that the thermostat operates the component according to the setting.

18. A method, comprising:
sending, by a server, an application program to a mobile computing terminal, wherein the mobile computing terminal has a display and a first network interface, wherein the mobile computing terminal hosts an operating system, wherein the application program is programmed to run in a technician mode on the operating system such that (1) the first network interface is capable of directly pairing with a second network interface of a thermostat connected to a component of an HVAC system and (2) the display is capable of displaying a Graphical User Interface (GUI) that enables a technician to (i) select a setting for the component and (ii) send the setting from the application program via the first network interface to the thermostat via the second network interface such that the thermostat operates the component according to the setting.

19. A system, comprising:
a mobile computing terminal having a display and a first network interface, wherein the mobile computing terminal hosts an operating system, wherein the operating system hosts an application program programmed to run in a technician mode such that (1) the first network interface is capable of directly pairing with a second network interface of a thermostat connected to a component of an HVAC system and (2) the display is capable of displaying a Graphical User Interface (GUI) that enables a technician to (i) select a setting for the component and (ii) send the setting from the application program via the first network interface to the thermostat via the second network interface such that the thermostat operates the component according to the setting.
